(19) United States
(12) Patent Application Publication
(10) Pub. No.: US 2014/0181712 A1
(43) Pub. Date: Jun. 26, 2014

(54) ADAPTATION OF THE DISPLAY OF ITEMS ON A DISPLAY

(71) Applicant: Nokia Corporation, Espoo (FI)

(72) Inventors: Andres Lucero, Tampere (FI); Petri Piippo, Lempaala (FI); Juha Arrasvuori, Tampere (FI); Marion Boberg, Suinula (FI)

(73) Assignee: Nokia Corporation, Espoo (FI)

(21) Appl. No.: 14/105,992

(22) Filed: Dec. 13, 2013

(30) Foreign Application Priority Data
Dec. 23, 2012 (IB) PCT/IB2012/057271

(51) Int. Cl. G06F 3/0484; G06F 3/0482; G06F 3/0481

(52) U.S. Cl. CPC G06F 3/04842; G06F 3/04817; G06F 3/0482
USPC 715/765

(57) ABSTRACT

An apparatus receives information about at least one item displayed on a display and singled out by a user via a user interface, wherein the at least one singled out item is a part of a group of items displayed on the display on a par with each other. The apparatus determines items, which are displayable on a display and which are related according to a given criterion to the at least one singled out item. The same or another apparatus causes a replacement of displayed items of the group of items that are not related according to the given criterion to the at least one singled out item by items determined to be related to the at least one singled out item such that the at least one singled out item is displayed as a part of a group of items displayed on the display on a par with each other and comprising the determined items.

### CROSS-REFERENCE TO RELATED APPLICATION

This application claims priority to and the benefit of International Application No. PCT/IB2012/057271, filed Dec. 13, 2012, the entire contents of which are incorporated herein by reference.

### FIELD OF THE DISCLOSURE

The invention relates to the display of items on a display and more specifically to supporting an adaptation of a display of items on a display.

### BACKGROUND

Items that can be displayed on a display of a device may comprise for instance photographs, icons, keys, calendar entries, etc.

A user input to the device may relate to displayed items. A user input can be used for instance for selecting items, for highlighting items, for adding and removing items, for bringing out or highlighting controls that are associated to items, or for structuring items.

### SUMMARY OF SOME EMBODIMENTS OF THE INVENTION

A method is described which is performed by at least one apparatus. The method comprises receiving information about at least one item displayed on a display and singled out by a user via a user interface, wherein the at least one singled out item is a part of a group of items displayed on the display on a par with each other. The method moreover comprises determining items, which are displayable on a display and which are related according to a given criterion to the at least one singled out item. The method moreover comprises causing a replacement of displayed items of the group of items that are not related according to the given criterion to the at least one singled out item by items determined to be related to the at least one singled out item such that the at least one singled out item is displayed as a part of a group of items displayed on the display on a par with each other and comprising the determined items.

Moreover a first apparatus is described which comprises means for realizing the actions of the presented method.

The means of this apparatuses can be implemented in hardware and/or software. They may comprise for instance a processor for executing computer program code for realizing the required functions, a memory storing the program code, or both. Alternatively, they could comprise for instance circuitry that is designed to realize the required functions, for instance implemented in a chipset or a chip, like an integrated circuit.

Moreover a second apparatus is described, which comprises at least one processor and at least one memory including computer program code, the at least one memory and the computer program code configured to, with the at least one processor, cause an apparatus at least to perform the actions of the presented method.

Moreover a system is described which comprises means for realizing the actions of the presented method. The means may optionally be distributed to several apparatuses, for instance to a user device and a server. In an example embodiment, the system comprises at least two apparatuses and each apparatus comprises at least one processor and at least one memory including computer program code, the at least one memory and the computer program code configured to, with the at least one processor, cause the apparatus at least to perform one of the actions of the presented method.

Moreover a non-transitory computer readable storage medium is described, in which computer program code is stored. The computer program code causes an apparatus to perform the actions of the presented method when executed by a processor.

The computer readable storage medium could be for example a disk or a memory or the like. The computer program code could be stored in the computer readable storage medium in the form of instructions encoding the computer-readable storage medium. The computer readable storage medium may be intended for taking part in the operation of a device, like an internal or external hard disk of a computer, or be intended for distribution of the program code, like an optical disc.

It is to be understood that also the respective computer program code by itself has to be considered an embodiment of the invention.

Any of the described apparatuses may comprise only the indicated components or one or more additional components.

The described system may comprise only the indicated components or one or more additional components.

In one embodiment, the described methods are information providing methods, and the described first apparatuses are information providing apparatuses. In one embodiment, the means of the described first apparatus are processing means.

In certain embodiments of the described methods, the methods are methods for supporting an adaptation of a display of items. In certain embodiments of the described apparatuses, the apparatuses are apparatuses supporting an adaptation of a display of items.

It is to be understood that the presentation of the invention in this section is merely based on examples and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an example embodiment of an apparatus;

FIG. 2 is a flow chart illustrating an example embodiment of a method;

FIG. 3 is a schematic block diagram of an example embodiment of a system;

FIG. 4 is a flow chart illustrating example operations in the system of FIG. 3;

FIG. 5a-c are schematic diagrams illustrating a first example use case;

FIG. 6a-b are schematic diagrams illustrating a second example use case;

FIG. 7a-b are schematic diagrams illustrating a third example use case;

FIG. 8 is a diagram schematically illustrating possible user actions for selecting a search criterion;

FIG. 9a-c are schematic diagrams illustrating a fourth example use case; and

FIG. 10a-b are schematic diagrams illustrating a fifth example use case.

### DETAILED DESCRIPTION OF THE FIGURES

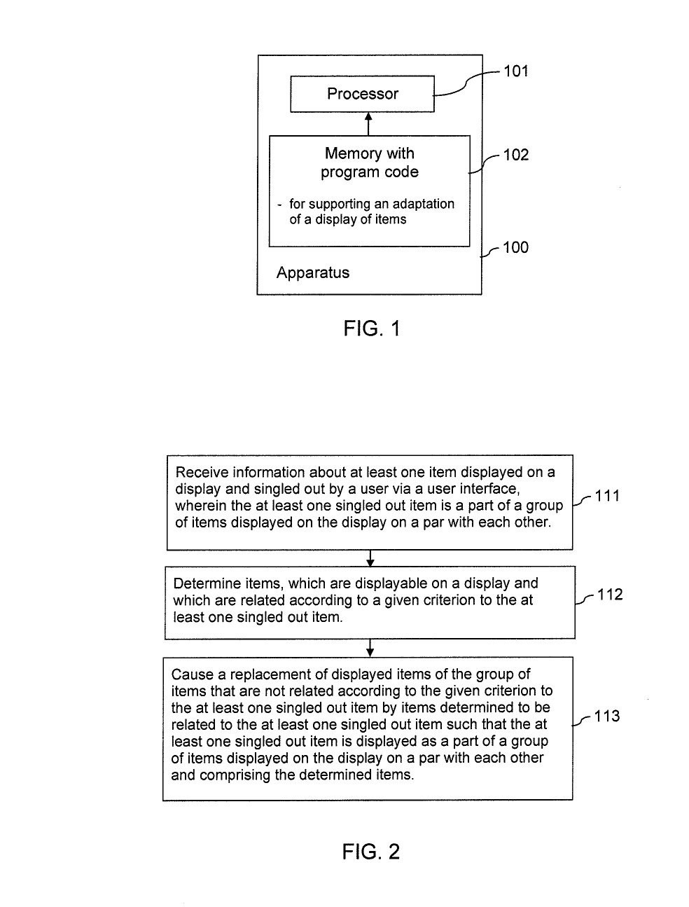

FIG. 1 is a schematic block diagram of an example apparatus 100. Apparatus 100 comprises a processor 101 and, linked to processor 101, a memory 102. Memory 102 stores computer program code for supporting an adaptation of a display of items. Processor 101 is configured to execute computer program code stored in memory 102 in order to cause an apparatus to perform desired actions.

Apparatus 100 could be for instance a server or a mobile or stationary user device. A mobile user device could be for example a communication terminal, like a mobile phone, a smart phone, a laptop, a tablet computer, etc. A stationary user device could be for example a personal computer. Apparatus 100 could equally be a module, like a chip, circuitry on a chip or a plug-in board, for a server or for a user device. Apparatus 100 is an example embodiment of an apparatus according to the invention. Optionally, apparatus 100 could comprise various other components, like a data interface component, user interfaces, a further memory, a further processor, etc.

An operation of apparatus 100 will now be described with reference to the flow chart of FIG. 2. The operation is an example embodiment of a method according to the invention. Processor 101 and the program code stored in memory 102 may cause an apparatus to perform the operation when the program code is retrieved from memory 102 and executed by processor 101. The apparatus that is caused to perform the operation can be apparatus 100 or some other apparatus, in particular a device comprising apparatus 100.

The apparatus receives information about at least one item displayed on a display and singled out by a user via a user interface, wherein the at least one singled out item is a part of a group of items displayed on the display on a par with each other. (action 111)

The apparatus determines items, which are displayable on a display and which are related according to a given criterion to the at least one singled out item. (action 112)

The apparatus causes a replacement of displayed items of the group of items that are not related according to the given criterion to the at least one singled out item by items determined to be related to the at least one singled out item such that the at least one singled out item is displayed as a part of a group of items displayed on the display on a par with each other and comprising the determined items. (action 113)

If the apparatus is a server or a module for a server, the actual user input and the actual display of items may take place at a separate user device. It is to be understood that in certain embodiments, the operations presented in FIG. 2 could also be performed in a distributed manner by at least two apparatus. For instance, actions 111 and 112 could be performed at a server and action 113 could be performed at a user device.

In many situations, items that a user currently wishes to view are only partially presented on a display; that is, either only some of the relevant items are displayed or a reduced version of the relevant items is displayed. At the same time, items may be presented on the display that are not of interest to the user at present. Presenting all available items of a kind in a reasonable size would often require too much space for the presentation; and even if feasible, the user would have more trouble finding a particular item among the increased group of displayed items. A manual selection of all items that are to be displayed might be rather burdensome to the user.

Certain example embodiments of the invention therefore provide that an apparatus may cause a replacement of currently irrelevant items in a group of displayed items by currently relevant items. The replacement may take place automatically in response to a singling out of at least one of the displayed items by the user.

Certain embodiments of the invention may have the effect that replaced unrelated items do not consume space on the display anymore. As a result, more relevant items or more complete relevant items may be displayed without increasing the display and without reducing the size of the presentation of the displayed items. When unrelated items are removed by the replacement, it also becomes easier for the user to identify related items on the display. Since the required user input may be limited to a singling out of one or more displayed items, also the effort of a user is limited.

The items are assumed to be displayed on a par with each other; that is, they may not belong to different layers of a hierarchical structure. The singling out of an item by a user may take place in any desired manner. In the case of a touchscreen, for instance a selection by hovering over an item with a finger or pen, by pressing an item, by pressing and dragging an item in a particular direction, or by applying a multi-finger press or movement may be supported. In case a user interface comprises a mouse or physical keys, for instance a selection by hovering over an item with a cursor, by clicking an item or by dragging an item may be supported. A selection by hovering over an item may require for instance a hovering over the item for a predetermined or settable minimum time.

Apparatus 100 illustrated in FIG. 1 and the method illustrated in FIG. 2 may be implemented and refined in various ways.

In an example embodiment, a displayed item is replaced by a determined item such that the determined item is shown to fly into the display and to replace the displayed item at its position on the display. Alternatively, a displayed item could be replaced by a determined item such that the displayed item is turned around, with the determined item appearing arranged on a backside of the displayed item. Both may have the effect that the user clearly notes the change. Displayed items that are to be replaced may disappear from the display by being shown to fly out of the display, by fading out, by being covered by a respective related item or by being turned around. Displayed unrelated items that are not replaced by any related item may equally be removed from the display.

In an example embodiment, a displayed item that is replaced by a determined item is selected in response to a user input via the user interface. This may have the effect that the replacement can be realized in a flexible manner, for instance starting from the top or from the right, etc.

In an example embodiment, the at least one singled out item is displayed at its original position when displayed as a part of the group of the determined items. This may have the effect of being least irritating to a user who singled out this item. In an alternative embodiment, however, the at least one singled out item could also always be displayed at a first position, when displayed as a part of the group of the determined items. The singled out item may be displayed in exactly the same manner as before, when displayed as a part of the group of the determined items, or in a modified manner.

In an example embodiment, the at least one singled out item may comprise a plurality of items. Determining items, which are related according to a given criterion to the at least one singled out item, may then comprise determining items that are related to each of the singled out items. For example, if two images of two different persons are singled out, only images may be determined, which show both of these persons. Alternatively, determining items, which are related according to a given criterion to the at least one singled out item, could comprise determining items that are related to at least one of the singled out items. For example, if two images of two different persons are singled out, all images may be determined, which show any one or both of these persons.

The items of a group of items may not only be images, but any kind of items that are displayed on par with each other. In an example embodiment, the items are photographic images. In another example embodiment, the items are images representing pieces of music. In another example embodiment, the items comprise text entries. In another example embodiment, the items comprise text of calendar entries. In another example embodiment, the items are keys of a keyboard with a particular assignment of a letter, number, sign etc. In another example embodiment, the items are waypoints or points of interest. Such items may be displayed for instance by a navigation application. In an example embodiment, the items are non-directory and non-menu items; that is, they are no intermediate elements of a hierarchical structure but rather content.

In an example embodiment, the given criterion comprises a criterion that is predetermined for a particular type of items. This may have the effect that the handling is particularly easy for a user. In another example embodiment, the given criterion comprises a criterion that is selected from one of a number of predetermined criteria for a particular type of items, depending on a manner of singling out the at least one item by the user via the user interface. This may have the effect that the same type of items may allow for an automatic exchange of different kinds so that a high flexibility is achieved. It is to be understood that a given criterion or several given criteria may be linked to a particular type of items directly or indirectly. For example, a criterion or several criteria may also be linked to a particular application that is suited to display a particular type of items.

In an example embodiment, the considered criterion comprises that the items to be determined are images of social contacts of a person in an image corresponding to the at least one singled out item. In another example embodiment, the considered criterion comprises that the items to be determined are images of a same person as a person in an image corresponding to the at least one singled out item. In another example embodiment, the considered criterion comprises that the items to be determined are images of a same date or of a same location or of a same topic or of a same color scheme as an image corresponding to the at least one singled out item.

In another example embodiment, the considered criterion comprises that the items to be determined are calendar entries on a same topic or for a same starting time or for a same location or for a same group of people as a calendar entry corresponding to the at least one singled out item. In another example embodiment, the considered criterion comprises that the items to be determined are representations of pieces of music having a characteristic in common with a piece of music represented by the at least one singled out item. The characteristic could be for instance the style of music, the artist, the composer, etc.

In another example embodiment, the considered criterion comprises that the items to be determined are keys of keypad expected to be required by a user in view of a key corresponding to the at least one singled out item.

In another example embodiment, the considered criterion comprises that the items to be determined are images of products of a same kind or of a same manufacturer as a product in an image corresponding to the at least one singled out item. In another example embodiment, the considered criterion comprises that the items to be determined are images of products that are interoperable with a product in an image corresponding to the at least one singled out item. For example, an original presentation on a display might show competing or otherwise unrelated products that are offered by an online vendor. When a user selects one of the products, competing or otherwise unrelated products may be replaced with products related to the selected items. This may be useful to a user, as it helps identifying and purchasing related products to extend the selected item. For example, if the user selected a camera from a list of cameras by multiple manufacturers, the other cameras could be removed from the list, and in their place products related to the chosen camera could be shown, such as battery packs, flashes, lenses, memory cards, etc., that are suited for use with the selected camera.

In an example embodiment, the considered criterion comprises a degree of a relation between a singled out item and items to be determined. For example, if a singled out item is an image of a social contact, the criterion could be to determine images of first degree social contacts or images of first and second degree social contacts. Alternatively, for example, if a singled out item is an image of a social contact, the criterion could be to determine images of social contacts with at least five existing photographs showing both social contacts together.

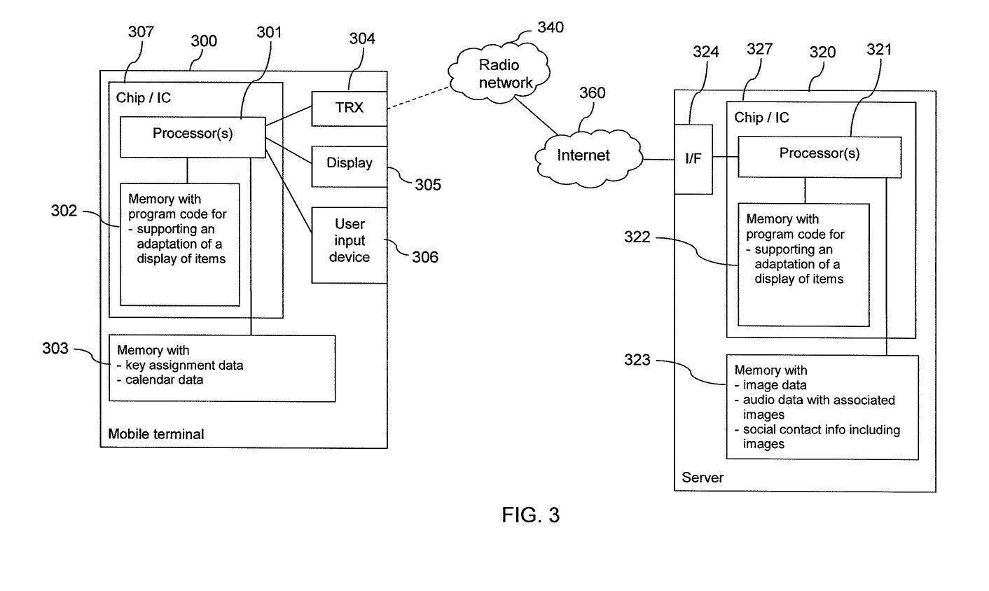

FIG. 3 is a schematic block diagram of an example system, which supports an adaptation of a display of items.

The system comprises a mobile terminal 300 as an example user device and a server 320. The mobile terminal 300 may access the server 320 via a radio network 340 and the Internet 360.

Mobile terminal 300 may be for instance a smartphone or a table computer. It comprises a processor 301 that is linked to a first memory 302, to a second memory 303, to a communication unit (TRX) 304, to a display 305 and to a user input device 306.

Processor 301 is configured to execute computer program code, including computer program code stored in memory 302, in order to cause mobile terminal 300 to perform desired actions.

Memory 302 stores computer program code for supporting an adaptation of a display of items, for example similar program code as memory 102. The program code could belong for instance to a comprehensive application supporting a management and display of stored data. In addition, memory 302 may store computer program code implemented to realize other functions, as well as any kind of other data. Memory 303 may store for instance data for keys of a virtual keypad as example items and/or data of calendar entries as further example items. Communication module 304 comprises a transceiver. It could be or linked to, for instance, a wireless local area network (WLAN) module or a cellular engine. Display 305 and user input device 306 could be realized for instance in the form of a touchscreen as an example user interface. Alternatively or in addition, other user input devices, like a mouse, a trackball or a keyboard or even a microphone, could form a part of the user interface.

Processor 301 and memory 302 may optionally belong to a chip or an integrated circuit 307, which may comprise in addition various other components, for instance a further processor or memory.

Server 320 may be for instance a server managing stored content, a server of an online vendor or some other kind of server. It comprises a processor 321 that is linked to a first memory 322, to a second memory 323 and to an interface (I/F) 324.

Processor 321 is configured to execute computer program code, including computer program code stored in memory 322, in order to cause server 320 to perform desired actions. Memory 322 stores computer program code for supporting an adaptation of a display of items, for example similar program code as memory 102. The program code could belong for instance to a comprehensive application supporting a management of stored data. In addition, memory 322 may store computer program code implemented to realize other functions, as well as any kind of other data. Memory 323 may store for instance data of images as example items and/or audio data with associated images as further example items and/or social contact information including images of the contacts as further example items. It is to be understood that a memory storing this data could also be external to server 320; it could be for instance on another physical or virtual server. Interface 324 is a component which enables server 320 to communicate with other devices, like mobile terminal 300, via network 360. Interface 324 could comprise for instance a TCP/IP socket.

Processor 321 and memory 322 may optionally belong to a chip or an integrated circuit 327, which may comprise in addition various other components, for instance a further processor or memory.

The radio access network 340 could be for instance a cellular communication network or a WLAN. A cellular communication network 340 could be based on any kind of cellular system, for instance a Global System for Mobile Communications (GSM), a 3rd Generation Partnership Project (3GPP) based cellular system, a 3GPP2 system or a Long Term Evolution (LTE) system, or any other type of cellular system.

It is to be understood that the data indicated to be stored in memories 303 and 323 is only an example. There could be data for only one type of item in only one of the memories, or data for any number of types of items in any one or both memories. Each set of data for a particular item could comprise metadata, which comprises a description of a respective content and thus allows determining a relation between different sets of stored content. Metadata associated with a photograph could indicate for instance a time at which the photograph was taken, a location at which the photograph was taken and an identification of at least one person shown in the photograph, if any. An indication of time and/or location could be added to a photograph for example automatically by a device that is used for capturing the photograph, if the device comprises a clock and/or positioning capabilities. The identification of a person could be entered manually by a user or be based on face recognition. Metadata could also be stored separate from but with a link to the actual data to which it relates, either in the same or in a different memory. It is further to be understood that program code for supporting an adaptation of a display of items could only be stored in one of memories 302 and 322.

Component 307 or mobile terminal 300 and/or component 327 or server 320 could correspond to example embodiments of an apparatus according to the invention.

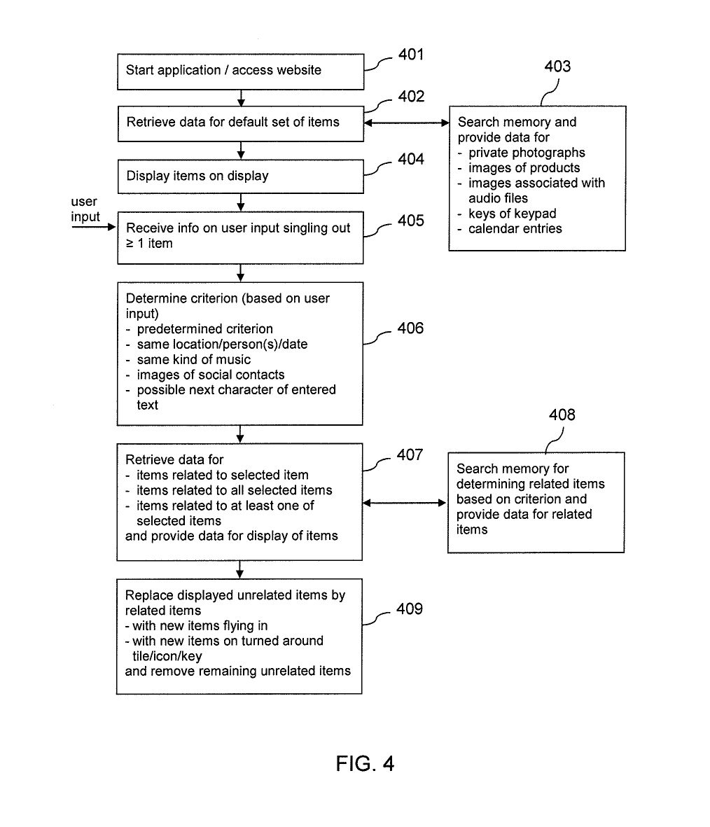

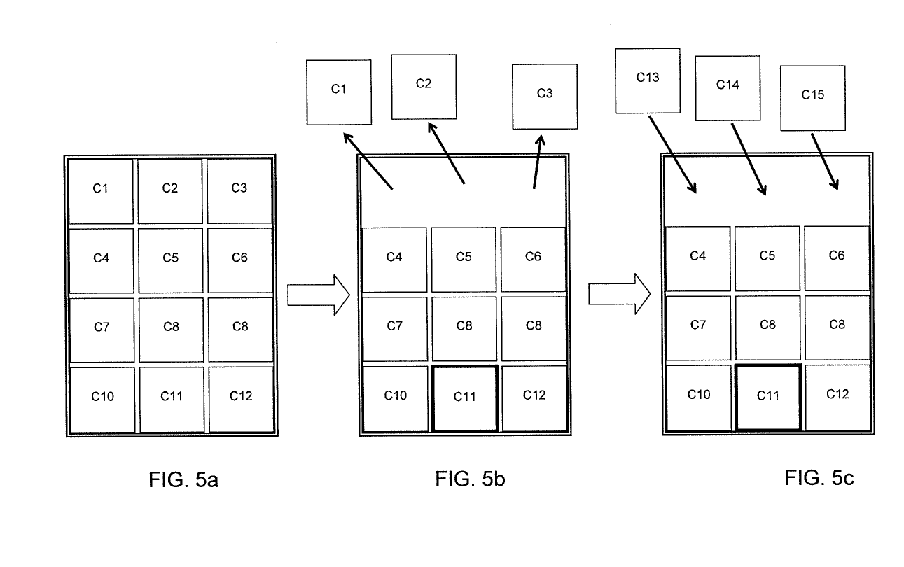

An example operation in the system of FIG. 3 will now be described on a general basis with reference to the flow chart of FIG. 4, while examples of use cases will be described with reference to the diagrams of FIGS. 5 to 10.

A user may start an application presenting items on the display 305 at mobile terminal 300. Instead of starting a local application, a user could also cause mobile terminal 300 to access a website offered by server 320, which presents items on the display of user devices. (action 401)

The data for a default set of items for the presentation is retrieved from a memory. (action 402) The default set can be based for instance a selection of the user or a selection of some service provider. The memory can be memory 303 or memory 323.

For retrieving the data, the concerned memory 303, 323 is searched for the required data. (action 403) Depending on the started application or the accessed website, the data may comprise for example data of images, like private photographs, images of products or images associated with audio files, or it may comprise data of keys of a keypad or data of calendar entries, etc.

The items, for which data has been retrieved, are displayed on a par with each other on display 305. (action 404) The actual presentation may be under control of mobile terminal 300—if the presentation is a presentation of a local application—or of server 320—if the presentation is a presentation on a website.

A user may now single out at least one of the displayed items using user input device 306. The singling out may be performed in several ways. In case the user input device 306 is a part of a touchscreen, an item may be singled out for instance by touching the item, by touching the item and dragging it into a certain direction, by hovering over the item, etc. In case the user input device 306 comprises a mouse or a trackball, an item may be singled out for instance by moving a cursor over the item, with or without clicking the item. At least one item could also be singled out by entering a keyword that matches a characteristic of the at least one item. Information on the at least one item singled out by the user is received within mobile terminal 300 and—if forwarded by mobile terminal 300—by server 320. (action 405) The information may comprise for instance an identification of the at least one item or an indication of the position on display 305 that enables an identification of the at least one item.

Next, a criterion for items being related items is determined. (action 406)

The criterion may be a predetermined criterion for the running application or the accessed website, or a predetermined criterion for the concerned type of items. It is to be understood that in this case, an explicit action of determining the criterion is not required necessarily. Alternatively, several criteria may be defined for a particular application or website or for a particular type of item. For example, in case the displayed items are photographs, available criteria may be to select photographs of the same person, of the same people, of the same location or of the same date. One of these criteria may then be selected in response to the user input.

Data for items that are related according to the determined criterion to a singled out item may now be retrieved from the concerned memory 303, 323. (action 407) If several items have been selected by the user, data for items may be retrieved that are related to all singled out items. Alternatively, data for items may be retrieved that are related to at least one of the singled out items.

For retrieving the data, the concerned memory 303, 323 is searched in order to determine the items that are related to the singled out item(s) according to the selected criterion. (action 408) The data of the determined items read from the concerned memory 303, 323 is provided for a display of the items on display 305.

In the presentation provided by the called application or the accessed website on display 305, unrelated displayed items may now be replaced by related items. (action 409) This can be achieved for instance by having the new items fly into the display 305. The unrelated displayed items may for example either fly out of the display 305 first, or they may be covered by the flying in related items. Alternatively, unrelated displayed items may turn around such that a related item seems to appear on the back. This approach may be used in particular, though not exclusively, if the items are presented on tiles or as keys.

Occasionally, there may be an overlap between originally displayed items and items that are determined to be related, in addition to the singled out item. To take account of this, different approaches are possible. In a first approach, generally all displayed items except for—or even including—the singled out item may be removed, for example by flying out or turning around, fading out, simply disappearing, etc. The determined related items may then take the place of the removed items. This approach may be used in particular in case the presentation of the relevant items is changed during the replacement, for example because more details of the items are to be shown. In another approach, exclusively the unrelated items may be replaced, while the originally displayed related items remain unchanged. In this case, it may be determined in addition, whether there is any coincidence between a displayed item and any determined relevant item. If this is the case, the displayed item is omitted from being replaced, and the determined relevant item is omitted as a replacement.

Performance of the actions presented in FIG. 4 may be distributed in different ways to mobile terminal 300 and server 320.

For instance, if the data of the displayed items is stored in memory 303 of mobile terminal 300, all actions may be performed at mobile terminal 300. With memory 303 storing calendar entry data and key data, as shown by way of example in FIG. 3, all actions could be performed at mobile terminal 300, if an application started by a user in action 401 presented a calendar or a virtual keypad on display 305.

Alternatively, if the data of the displayed items is stored in memory 323 of server 320, while an application presenting the items is executed by mobile terminal 300, actions 401, 402, 404-407 and 409 could be performed by mobile terminal 300 and actions 403 and 408 could be performed by server 320. Information on a user input may be detected at mobile terminal 300 and provided to server 320 along with the criterion determined in action 406, thus action 405 might be understood to be applicable to both, mobile terminal 300 and server 320, in this case. With memory 323 storing image data, as shown by way of example in FIG. 3, this approach could be used for example if an application started by a user in action 401 presented photographs of a photo album or social contacts or available audio files on display 305.

Further alternatively, if the data of the displayed items is stored in memory 323 and the items are displayed on a website handled by server 320, actions 401 and 405 could be performed by mobile terminal 300 and actions 402-409 could be performed by server 320. It is to be understood that in this case, the actual display of items in actions 404 and 409 takes place on display 305 of mobile terminal 300, but the content of the website may be controlled completely by server 320. Information on a user input may be detected at mobile terminal 300 and provided to server 320, thus action 405 might be understood to be applicable to both, mobile terminal 300 and server 320, in this case. With memory 323 storing image data, as shown by way of example in FIG. 3, this approach could be used if a website accessed by a user in action 401 is a website of an online vendor presenting images of products.

Processor 301 and program code stored in memory 302 cause mobile terminal 300 to perform any required action when the program code is retrieved from memory 302 and executed by processor 301. Processor 321 and program code stored in memory 322 cause server 320 to perform any required action when the program code is retrieved from memory 322 and executed by processor 321. Any communication between mobile terminal 300 and server 320, as far as required, may take place via radio network 340 and Internet 360.

FIGS. 5a to 5c are diagrams illustrating a first example use case, in which items are images of social contacts in a social network.

FIG. 5a is a schematic diagram of a part of a display 305 of terminal 300 presenting images of social contacts of a user. The presentation could be for example a result of actions 401 to 404 of FIG. 4. The images are arranged in a grid of 3×4 images, the images being denoted C1 to C12.

A user may now single out one of the contacts, for example by hovering above one of the images. In FIG. 5b, a singling out of the image C11 is indicated by bold lines. In the presented example, three contacts are not related to the selected contact with image C11. Their images C1, C2, C3 are shown to fly out of the display.

Instead, as shown in FIG. 5c, the images C13, C14, C15 of three contacts that are related to the contact with the selected image C11 are shown to fly into the display to fill the vacated places.

The replacement illustrated in FIGS. 5b and 5c may be for example a result of actions 405 to 409 of FIG. 4.

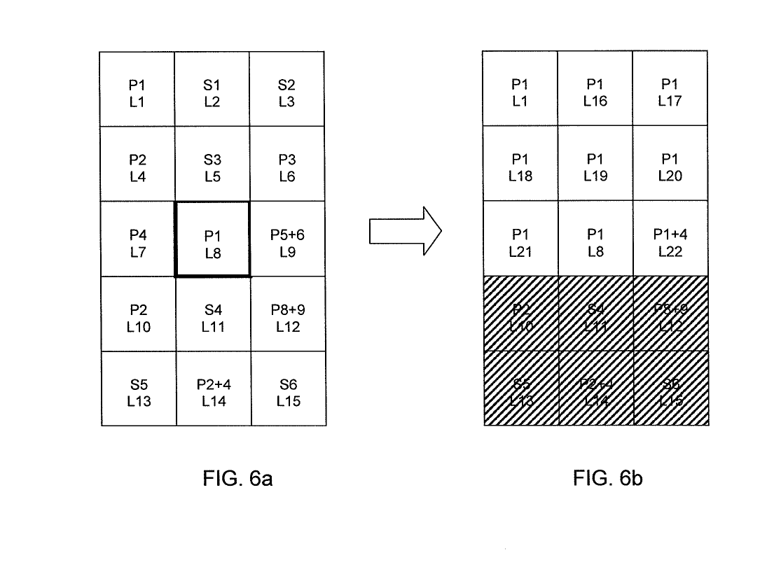

FIGS. 6a and 6b are diagrams illustrating a second example use case, in which items are photographs.

FIG. 6a is a schematic diagram of a display 305 of terminal 300 presenting photographs of an unsorted photo album. The presentation could be for example a result of actions 401 to 404 of FIG. 4. A user may browse the collection until a person of interest is found, so the presented photographs are not necessarily the first set of photographs that is presented when starting the application. The photographs are arranged by way of example in a grid of 3×5 photographs. For easy reference, each photograph is labeled in FIG. 6a by an indication of the presented person P1-P9 or the presented scene S1-S6 and by the location L1-L15 at which the photograph was taken. Some photographs may show more than one person, which is shown by the indications P5+6, P8+9 and P2+4. The first photograph “P1 L1” thus shows person P1 at location L1, the second photograph “S1 L2” shows scene S1 at location L2, etc.

A user may now single out one of the photographs, for example by touching one of the photographs, in order to obtain a presentation of photographs of the same person as shown in the singled out photograph. In FIG. 6a, a singling out of photograph “P1 L8” is indicated by bold lines. In the presented example of FIG. 6a, only one other photograph, photograph “P1 L1”, shows the same person P1.

When searching the unsorted photo album for more photographs of the same person P1, seven further photographs “P1 L16” to “P1 L21” and “P1+4 L22” may be found, e.g. in actions 405-408 of FIG. 4. Searching a photo album is to be understood to be a searching of a memory storing the data of the collection of photographs of the photo album.

FIG. 6b illustrates a replacement of unrelated photographs by related photographs. Photographs that have been determined to show the same person P1 appear by means of an animation from the top, for instance from outside the display, while the unrelated photos gently fade away. Some photographs that are fading away without being replaced are indicated in the lower part of FIG. 6b with hatching. The display as illustrated in FIG. 6b may be for example a result of action 409 of FIG. 4.

Instead of photographs relating to the same persons, photographs relating to other criteria, like the same location, or the same date, might be determined for the replacement.

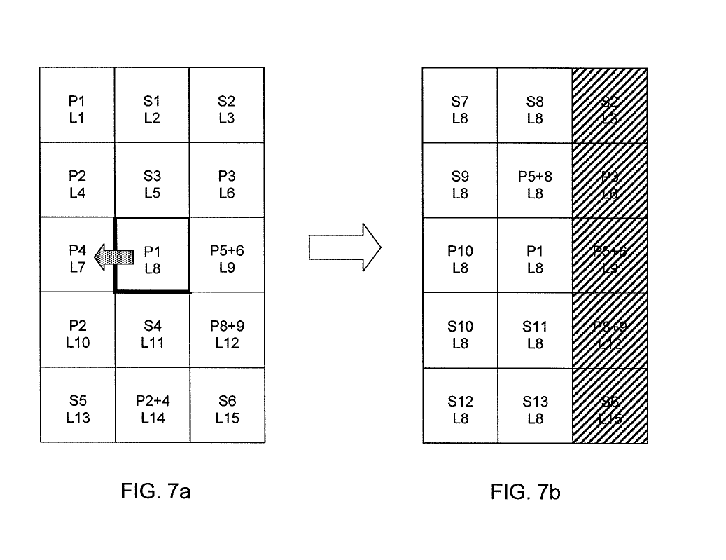

FIGS. 7a and 7b are diagrams illustrating a third example use case, in which items are photographs. However, this use case allows automatically assembling photographs of the same location.

FIG. 7a is identical to FIG. 6a.

A user may single out one of the photographs, for example by touching one of the photographs, in order to obtain a presentation of photographs of the same location as shown in the singled out photograph. In FIG. 7a, a singling out of photograph “P1 L8” is indicated again by bold lines. The user could single out the photograph by touching it and by moving it to the left, as indicated by a dotted arrow in FIG. 7a.

When searching the unsorted photo album for photographs of the same location L8, nine further photographs “S7 L8” to “S13 L8”, “P10 L8” and “P5+8 L8” may be found, e.g. in actions 405-408 of FIG. 4.

A replacement of unrelated photographs by related photographs is shown in FIG. 7b. Since the user moved the singled out photograph “P1 L8” to the left, the photographs that were determined to be taken at the same location L8 appear and fill up places of unrelated photographs from the left, while all unrelated photos gently fade away. The photographs that are fading away without being replaced are indicated on the right part of the display with hatching. The display as illustrated in FIG. 7b may be for example a result of action 409 of FIG. 4.

If the user had moved the singled out photograph “P1 L8” to the right instead, found photographs related to the same location could appear from the right; if the user had moved the singled out photograph to the top instead, found photographs related to the same location could appear from the top; if the user had moved the singled out photograph downwards instead, found photographs related to the same location could appear from the bottom.

Thus, while the same photograph “P1 L8” of the same set of photographs was singled out in FIG. 6a and in FIG. 7a, the related photographs used for a replacement are different. Furthermore, while in the embodiment of FIGS. 6a and 6b, the new items may always be arranged from top to bottom, the location of new items may be selected by the user in the embodiment of FIGS. 7a and 7b.

A user input could not only be used for selecting the direction from which new items fill up a display, but alternatively or in addition for selecting the criterion based on which new items are to be determined.

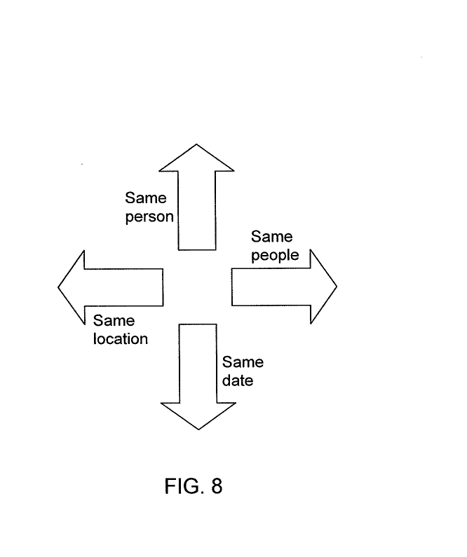

FIG. 8 shows possible user inputs including a moving a singled out item to a particular direction.

When a user moves a singled out photograph to the left, as indicated by an arrow to the left in FIG. 8, photographs of the same location could appear from the left, as shown in FIG. 7b. When a user moves a singled out photograph to the top, as indicated by an arrow to the top in FIG. 8, photographs of the same person could appear from the top. When a user moves a singled out photograph to the right, as indicated by an arrow to the right in FIG. 8, photographs of the same people could appear from the right. When a user moves a singled out photograph downwards, as indicated by an arrow to the bottom in FIG. 8, photographs of the same date could appear from the bottom. In other embodiments, photographs could appear from a direction opposite to the movement of a photograph by a user. Photographs could also appear from below, fade in, or appear from several directions, etc.

It is to be understood that different kinds of user input could be used for singling out an item and selecting a particular criterion. For example, a single touch could result in an assembly of photographs of the same person, while a double touch could result in an assembly of photographs of the same date, etc. Equally, a touch by different numbers of fingers could result in different criteria.

Such shortcuts may be predetermined and fixed or definable by a user.

When different kinds of user input result in different criterion, the resulting criterion could also be shown on the display in order to enable the user to verify that the resulting criterion corresponds to the desired criterion.

The use cases presented with reference to FIGS. 6-8 may help a user to identify related photos, for example, when showing and explaining them to a friend.

A similar approach could be used with music collections to help the user to discover related songs or artists, or with products offered by an online vendor to help the user to discover related products.

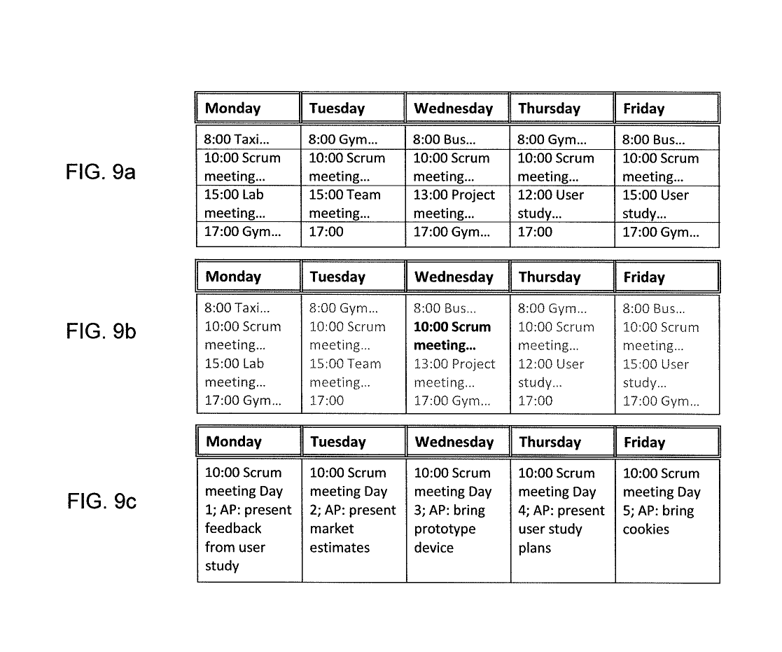

FIGS. 9a to 9c are diagrams illustrating a fourth example use case, in which items are calendar entries.

FIG. 9a shows a Monday-to-Friday view of a calendar application on display 305 of mobile terminal 300. The presentation could be for example a result of actions 401 to 404 of FIG. 4. It is to be understood that a user may switch between different weeks and different views, so the view presented in FIG. 9a may not necessarily be the first view when starting the calendar application. For each day, there are several entries in a respective cell. As a result, only few details of each entry are visible, for instance the time of an event and the beginning of a description of the event. Other possible views could comprise a complete week view or a month view etc.

A user may now single out one of the entries by hovering with a finger over the entry for a predetermined time or by pressing the entry. An example singled out entry “10:00 Scrum meeting . . . ” on Wednesday is indicated in FIG. 9b in bold writing.

Related entries throughout the week are determined, for example in line with actions 405-408 of FIG. 4. Entries may be related, for instance, because they relate to events taking place at the same location or having the same participants, or because they have the same keyword.

In FIG. 9a, there are for instance other entries “10:00 Scrum meeting . . . ”, which are related to the selected entry by time “10:00” and keyword “Scrum meeting”. These entries may be determined and the complete text of each of these entries may be retrieved.

Entries unrelated to the selected entry may then be replaced with the complete text available for those entries that have been determined to be related to the selected entry. To this end, the multiple cells per day shown in FIG. 9a are replaced with one large cell per day. Each large cell comprises comprehensive information on events in entries that are related to the singled out entry, as shown in FIG. 9c. The presentation illustrated in FIG. 9c may be for example a result of action 409 of FIG. 4.

Thus, unrelated entries are removed to give space to show the related entries in more detail. This may have the effect that a user can see more detailed information about related events.

Similarly as described with reference to FIGS. 7 and 8, a user may be enabled to influence the replacement of entries and/or the search criterion.

Pressing and dragging one calendar entry in a certain direction could cause the search for similar entries based on different criteria. For example, by pressing and dragging a calendar entry to the top may cause a search for entries relating to events of the same topic; by pressing and dragging a calendar entry to the right may cause a search for entries relating to events with the same people; by pressing and dragging a calendar entry downwards may cause a search for entries relating to events having the same starting time; and by pressing and dragging a calendar entry to the left may cause a search for entries relating to events at the same location.

Again, various other types of user input and criteria may be considered; and shortcuts for choosing between criteria may be predetermined and fixed or re-definable by a user.

It has to be noted that a corresponding approach can be applied to spreadsheet applications.

A similar approach could equally be used with a navigation application presenting a list of waypoints or points of interest to a user on display 305. When a user selects one waypoint, related waypoints may be determined. Unrelated waypoints may then be removed to show the related waypoints in larger font size. Waypoints presented with larger size may have the effect that they can be discerned more easily by a user. This can aid taking decisions such as deciding where to stop for lunch or a break along the route, etc.

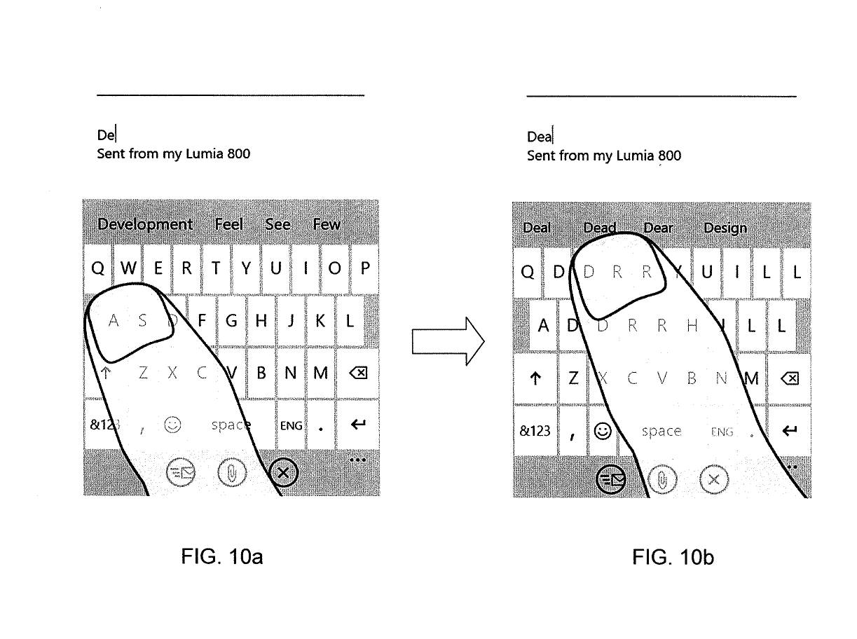

FIGS. 10a, 10b are diagrams illustrating a fifth example use case, in which items are keys of a keypad.

FIG. 10a shows a regular virtual keypad displayed on display 305 of mobile terminal 300, which may be presented for example as a result of actions 401 to 404 of FIG. 4. A user is typing a message by pressing keys of the virtual keypad, the text appearing on display 305 above the keypad. So far, the user has written “De” and is about to type an “a”.

Predictive text input is used to determine the possible word that the user is typing. If the user completes writing “Dea”, for instance, candidate words might be “Deal”, “Dead”, “Dear” and “Design”—the latter assuming that the “a” was pressed erroneously instead of an “s”.

In FIG. 10b, with “Dea” now shown to be written by the user, keys with letters that are not in the candidate words turn over to show on their backside letters that are in the candidate words. Thus, there are, for example, multiple keys with the letters “L”, “D” and “R”, because it is predicted that the user wishes to write “Deal”, “Dead” or “Dear”. The replacement letters are near the location of the letter that they duplicate. In FIG. 10b, the keys with letters “W”, “E” and “S” have been replaced by keys with letter “D”, the keys with letters “0”, “P” and “K” have been replaced by keys with letter “L”, and the keys with letters “T”, “F” and “G” have been replaced by keys with letter “R”. This may be for example a result of action 409 of FIG. 4.

The replacement of keys with particular letters may have the effect of making the typing faster as the user has more instances of the letters “D”, “L” and “R” to choose from.

In an example embodiment, some options to complete a word could furthermore appear above the keypad for selection by pressing, as shown in FIGS. 10a and 10b.

Summarized, certain embodiments of the invention may have the effect of achieving an improved user experience.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)
(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory, a random access memory, a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The functions illustrated by processor 101 or by processors 301 and/or 321 in combination with memory 102, 302 and 322, respectively, or the integrated circuits 307 and/or 327 can also be viewed as means for receiving information about at least one item displayed on a display and singled out by a user via a user interface, wherein the at least one singled out item is a part of a group of items displayed on the display on a par with each other; means for determining items, which are displayable on a display and which are related according to a given criterion to the at least one singled out item; and means for causing a replacement of displayed items of the group of items that are not related according to the given criterion to the at least one singled out item by items determined to be related to the at least one singled out item such that the at least one singled out item is displayed as a part of a group of items displayed on the display on a par with each other and comprising the determined items.

The program codes in memory 102, 302 and 322, respectively, by themselves or in combination, can also be viewed as comprising such means in the form of functional modules.

FIGS. 2 and 4 may also be understood to represent example functional blocks of computer program codes supporting an adaptation of a display of items on a display.

It will be understood that all presented embodiments are only examples, and that any feature presented for a particular example embodiment may be used with any aspect of the invention on its own or in combination with any feature presented for the same or another particular example embodiment and/or in combination with any other feature not mentioned. It will further be understood that any feature presented for an example embodiment in a particular category may also be used in a corresponding manner in an example embodiment of any other category.

What is claimed is:

1. A method performed by at least one apparatus, the method comprising:
receiving information about at least one item displayed on a display and singled out by a user via a user interface, wherein the at least one singled out item is a part of a group of items displayed on the display on a par with each other;
determining items, which are displayable on a display and which are related according to a given criterion to the at least one singled out item; and
causing a replacement of displayed items of the group of items that are not related according to the given criterion to the at least one singled out item by items determined to be related to the at least one singled out item such that the at least one singled out item is displayed as a part of a group of items displayed on the display on a par with each other and comprising the determined items.

2. The method according to claim 1, wherein one of:
a displayed item is replaced by a determined item such that the determined item is shown to fly into the display to a position of the displayed item on the display;
a displayed item is replaced by a determined item such that the displayed item is turned around, with the determined item appearing arranged on a backside of the displayed item; and
a displayed item that is replaced by a determined item is selected in response to a user input via the user interface.

3. The method according to claim 1, wherein the at least one singled out item is displayed at its original position when displayed as a part of the group of the determined items.

4. The method according to claim 1, wherein the at least one singled out item comprises a plurality of items and wherein determining items, which are related according to a given criterion to the at least one singled out item, comprises one of
determining items that are related to each of the singled out items; and
determining items that are related to at least one of the singled out items.

5. The method according to claim 1, wherein an item comprises one of:
an image;
a photographic image;
an image representing a piece of music;
a text entry;
a text of a calendar entry;
a key of a keyboard; and
a waypoint or a point of interest.

6. The method according to claim 1, wherein the given criterion comprises one of:
a criterion that is predetermined for a particular type of items; and
a criterion that is selected from one of a number of predetermined criteria for a particular type of items, depending on a manner of singling out the at least one item by the user via the user interface.

7. The method according to claim 1, wherein the criterion comprises one of:
the items to be determined being images of social contacts of a person in an image corresponding to the at least one singled out item;
the items to be determined being images of a same person as a person in an image corresponding to the at least one singled out item;
the items to be determined being images of a same date as an image corresponding to the at least one singled out item;
the items to be determined being images of a same location as an image corresponding to the at least one singled out item;
the items to be determined being images of a same topic as an image corresponding to the at least one singled out item;
the items to be determined being images of a same color scheme as an image corresponding to the at least one singled out item;
the items to be determined being calendar entries on a same topic as a calendar entry corresponding to the at least one singled out item;
the items to be determined being calendar entries for a same starting time as a calendar entry corresponding to the at least one singled out item;
the items to be determined being calendar entries for a same location as a calendar entry corresponding to the at least one singled out item;
the items to be determined being calendar entries for a same group of people as a calendar entry corresponding to the at least one singled out item;
the items to be determined being representations of pieces of music having a characteristic in common with a piece of music represented by the at least one singled out item;
the items to be determined being keys of keypad expected to be required by a user in view of a key corresponding to the at least one singled out item;
the items to be determined being images of products of a same kind as a product in an image corresponding to the at least one singled out item;
the items to be determined being images of products of a same manufacturer as a product in an image corresponding to the at least one singled out item; and
the items to be determined being images of products that are interoperable with a product in an image corresponding to the at least one singled out item.

8. The method according to claim 1, wherein the given criterion comprises a degree of a relation between a singled out item and items to be determined.

9. An apparatus comprising at least one processor and at least one memory including computer program code, the at least one memory and the computer program code configured to, with the at least one processor, cause an apparatus at least to perform:
receive information about at least one item displayed on a display and singled out by a user via a user interface, wherein the at least one singled out item is a part of a group of items displayed on the display on a par with each other;
determine items, which are displayable on a display and which are related according to a given criterion to the at least one singled out item; and
cause a replacement of displayed items of the group of items that are not related according to the given criterion to the at least one singled out item by items determined to be related to the at least one singled out item such that the at least one singled out item is displayed as a part of a group of items displayed on the display on a par with each other and comprising the determined items.

10. The apparatus according to claim 9, wherein the computer program code is configured to, with the at least one processor, cause the apparatus to perform at least one of the following:
replace a displayed item by a determined item such that the determined item is shown to fly into the display to a position of the displayed item on the display;
replace a displayed item by a determined item such that the displayed item is turned around, with the determined item appearing arranged on a backside of the displayed item; and
select a displayed item that is replaced by a determined item in response to a user input via the user interface.

11. The apparatus according to claim 9, wherein the computer program code is configured to, with the at least one processor, cause the apparatus to display the at least one singled out item at its original position when displaying the at least one singled out item as a part of the group of the determined items.

12. The apparatus according to claim 9, wherein the at least one singled out item comprises a plurality of items and wherein determining items, which are related according to a given criterion to the at least one singled out item, comprises one of
determining items that are related to each of the singled out items; and
determining items that are related to at least one of the singled out items.

13. The apparatus according to claim 9, wherein an item comprises one of:
an image;
a photographic image;
an image representing a piece of music;
a text entry;
a text of a calendar entry;
a key of a keyboard; and
a waypoint or a point of interest.

14. The apparatus according to claim 9, wherein the given criterion comprises one of:
a criterion that is predetermined for a particular type of items; and
a criterion that is selected from one of a number of predetermined criteria for a particular type of items, depending on a manner of singling out the at least one item by the user via the user interface.

15. The apparatus according to claim 9, wherein the criterion comprises one of:
the items to be determined being images of social contacts of a person in an image corresponding to the at least one singled out item;
the items to be determined being images of a same person as a person in an image corresponding to the at least one singled out item;
the items to be determined being images of a same date as an image corresponding to the at least one singled out item;
the items to be determined being images of a same location as an image corresponding to the at least one singled out item;
the items to be determined being images of a same topic as an image corresponding to the at least one singled out item;
the items to be determined being images of a same color scheme as an image corresponding to the at least one singled out item;
the items to be determined being calendar entries on a same topic as a calendar entry corresponding to the at least one singled out item;
the items to be determined being calendar entries for a same starting time as a calendar entry corresponding to the at least one singled out item;
the items to be determined being calendar entries for a same location as a calendar entry corresponding to the at least one singled out item;
the items to be determined being calendar entries for a same group of people as a calendar entry corresponding to the at least one singled out item;
the items to be determined being representations of pieces of music having a characteristic in common with a piece of music represented by the at least one singled out item;
the items to be determined being keys of keypad expected to be required by a user in view of a key corresponding to the at least one singled out item;
the items to be determined being images of products of a same kind as a product in an image corresponding to the at least one singled out item;
the items to be determined being images of products of a same manufacturer as a product in an image corresponding to the at least one singled out item; and
the items to be determined being images of products that are interoperable with a product in an image corresponding to the at least one singled out item.

16. The apparatus according to claim 9, wherein the given criterion comprises a degree of a relation between a singled out item and items to be determined.

17. The apparatus according to claim 9, wherein the apparatus is one of:
a server;
a component for a server;
a mobile device; and
a component for a mobile device.

18. A non-transitory computer readable storage medium in which computer program code is stored, the computer program code when executed by a processor causing an apparatus to perform the following:
receiving information about at least one item displayed on a display and singled out by a user via a user interface, wherein the at least one singled out item is a part of a group of items displayed on the display on a par with each other;
determining items, which are displayable on a display and which are related according to a given criterion to the at least one singled out item; and
causing a replacement of displayed items of the group of items that are not related according to the given criterion to the at least one singled out item by items determined to be related to the at least one singled out item such that the at least one singled out item is displayed as a part of a group of items displayed on the display on a par with each other and comprising the determined items.
